(19) United States
(12) Patent Application Publication
(10) Pub. No.: US 2011/0206452 A1
(43) Pub. Date: Aug. 25, 2011

(54) Locking coupler for a drive shaft

(76) Inventor: John F. Bently, New Richland, MN (US)

(21) Appl. No.: 12/660,404

(22) Filed: Feb. 25, 2010

(51) Int. Cl. G05G 1/12

(52) U.S. Cl. 403/361; 29/525

(57) ABSTRACT

A locking coupler for a drive shaft and a method therefor. The coupler includes a male and a female member, each including a male and a female coupler end and an opposite male and female shaft end. The coupler ends have a non-circular portion adapted to releasably receive the male coupler end within the female coupler end such that the ends have limited axial rotation relative to one another. The coupler also includes a detent cooperatively engageable with the male and female members to lock the male and female ends together. The detent is a button operable between an extended position and a depressed position, and a cooperative recess that receives the button when the button is in the extended position. The female coupler end includes a bore sidewall with a recessed portion, and the recessed portion and the button cooperate to provide a quick-connect relationship.

### BACKGROUND OF THE INVENTION

Generally, the invention relates to a coupler for assisting in securing connectable parts of a drive shaft together. Existing such devices are either complicated and difficult to connect and disconnect as desired, or if not so complicated, then they do not have sufficient durability to withstand the torque forces the coupler regularly encounters in rotational operation. Consequently, a new coupler is needed which will assist in easily and reliably joining together drive shaft to components in a selectively releasable relationship.

### SUMMARY OF THE INVENTION

The present invention is directed to avoiding at least the just discussed shortcomings. More particularly, the invention concerns a new coupler configuration for assisting in more easily and reliably joining together drive shaft components in a selectively releasable relationship. In this way, the coupler, and related drive shaft, can better handle the rotational torque forces placed upon such components during rotational drive of the drive shaft, while also enabling easy connection and disconnection of the components as desired. This can be advantageous, for example, when used to drive a cleaning brush or assembly for cleaning duct work or the like. One such existing drive shaft system for which the present invention may bring an improvement, is seen in Applicant's patent, U.S. Pat. No. 5,617,609 entitled “AIR NOZZLE/FLEXIBLE WHIP CLEANING MEANS FOR DUCTWORK”, which is incorporated fully herein by reference. An example of a cleaning brush for which the present invention may bring an improvement, is seen in Applicant's patent U.S. Pat. No. 7,644,465 entitled “COMPONENT BRUSH SYSTEM”, which is incorporated fully herein by reference. The versatility, simplicity and durability of the new coupler may further advantage it over any prior device. All this can be accomplished, for example, with some or all of the features of the present locking coupler.

The invention concerns a locking coupler for a drive shaft. The coupler includes a male member which includes a male coupler end and an opposite male shaft end. The male coupler end has a non-circular circumference relative to an axis of the male member. The coupler also includes a female member which includes a female coupler end and an opposite female shaft end. The female coupler end includes a non-circular bore adapted to releasably receive the non-circular male coupler end within the female coupler end such that when the female coupler end and the male coupler end are releasably engaged together they can rotate axially relative to one another only between the ranges of greater than −180 degrees and less than 180 degrees. The coupler also includes a detent cooperatively engageable with the male and female members to lock the male and female ends together when the male coupler end is received within the female coupler end. The detent includes a button operable between an extended position and a depressed position and a cooperative recess that receives the button when the button is in the extended position. The female coupler end includes a bore sidewall having an inner circumference and an outer circumference with the bore sidewall including a recessed portion between the inner circumference and the outer circumference adjacent an outer lip of the bore sidewall and thereby enlarging the bore at the recessed portion. The button includes a cylindrical base with an angled cap on top of the cylindrical base and the angled cap engaging the recessed portion in a first position when the male member begins to be received into the bore and the button is in the extended position. The angled cap engages the bore in a second position when the male member is further received into the bore and the button is in the depressed position. The angled cap is spaced from the recessed portion and received in the cooperative recess in a third position when the male member and the female member are releasably engaged together and the button is in the extended position.

The invention also concerns optional features for a locking coupler for a drive shaft. The coupler includes a male member which includes a male coupler end and an opposite male shaft end. The male coupler end has a non-circular circumference relative to an axis of the male member. The coupler also includes a female member including a female coupler end and an opposite female shaft end. The female coupler end includes a non-circular bore adapted to releasably receive the non-circular male coupler end within the female coupler end such that the female coupler end and the male coupler end engage each other in a mated relationship which provides substantially no axial rotation of the male member relative to the female member. The coupler also includes a detent cooperatively engageable with the male and female members to lock the male and female ends together when the male coupler end is received within the female coupler end. The detent includes a button operable between an extended position and a depressed position and a cooperative recess that receives the button when the button is in the extended position, and the detent principally serves to prevent disengagement of the male member from the female member in a longitudinal direction of the members and the detent does not substantially prevent axial movement of the male member relative to the female member when the male and female members are engaged together. The female coupler end includes a bore sidewall having an inner circumference and an outer circumference with the bore sidewall including a recessed portion between the inner circumference and the outer circumference adjacent an outer lip of the bore sidewall and thereby enlarging the bore at the recessed portion. The button includes a cylindrical base with an angled cap on top of the cylindrical base and the angled cap engages the recessed portion in a first position when the male member begins to be received into the bore and the button is in the extended position. The angled cap engages the bore in a second position when the male member is further received into the bore and the detent is in the depressed position. The angled cap is spaced from the recessed portion and received in the cooperative recess in a third position when the male member and the female member are releasably engaged together and the button is in the extended position.

The invention further concerns a method for joining a locking coupler for a drive shaft, with the locking coupler including the features discussed herein. The method includes pushing the male member into the bore such that the angled cap engages the recessed portion and the button is in the extended position. The method also includes, and advantageously sequentially next, pushing further the male member into the bore such that the angled cap engages the bore and the button is in the depressed position. The method also includes, and advantageously sequentially next, engaging releasably together the male member and the female member such that the angled cap is spaced from the recessed portion and received in the cooperative recess and the button is in the extended position. Further, the method also advantageously includes, limiting axial rotation of the male member relative to the female member when the female coupler end and the male coupler end are engaged together.

Still further, the invention concerns various optional configurations of the male and female coupler ends, the male and female shaft ends, and the detent for the members.

These and other features and functions of the present invention will be explained and understood upon reviewing the following detailed description and with reference to the accompanying drawings.

### BRIEF DESCRIPTION OF THE DRAWINGS

FIG. 1 is a perspective view of the invention with the male member releasably io engaged together with the female member.

FIG. 2 is a perspective view of the invention seen in FIG. 1, now with the male member releasably disengaged from the female member.

FIG. 3A is a diagrammatic representation of a cross-sectional view of an alternate embodiment of the invention seen in FIG. 1, with the coupler in a first position.

FIG. 3B is a diagrammatic representation of a cross-sectional view of the embodiment of the invention seen in FIG. 3A, with the coupler in a second position.

FIG. 3C is a diagrammatic representation of a cross-sectional view of the embodiment of the invention seen in FIG. 3A, with the coupler in a third position.

FIG. 4 is an end view of the female member seen in FIG. 3A, taken from the female coupler end.

FIG. 5 is an end view of the male member seen in all FIGs. but FIG. 4, taken from the male coupler end.

### DETAILED DESCRIPTION OF THE INVENTION

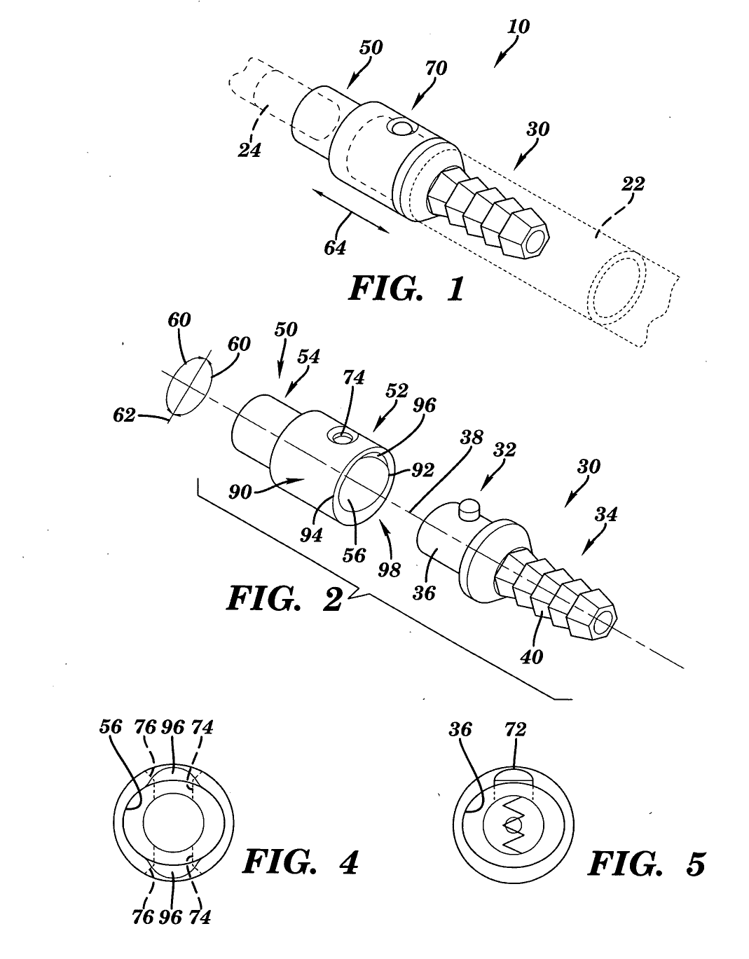

Referring to the Figures, and particularly FIG. 1, for example, there is seen a locking coupler 10 for a drive shaft, such as representative drive shaft portions 22 and 24. Generally, the coupler 10 includes a male member 30, a female member 50 and a detent 70, that cooperate to connect and disconnect drive shaft portions 22 and 24, as desired.

Now referring to FIG. 2, for example, the male member 30 includes a male coupler end and an opposite male shaft end 34. The male coupler end 32 has a non-circular circumference 36 relative to an axis 38 of the members 30, 50. The non-circular shape of the circumference 36 could be any regular or irregular shape, just as long as it is not a circle relative to a cross-section taken orthogonal to longitudinal axis 64. Such non-circular shape could be oval, square, rectagonal, triangular, symmetrical, non-symmetrical, polygonal, circular with only a portion non-circular (e.g., a protrusion on the male or female member and a mating recess for the protrusion on the female or male member, respectively, or a keyed relationship), the combination of any of these or similar variations.

The female member includes a female coupler end 52 and an opposite female shaft end 54. The female coupler end 52 includes a non-circular bore 56. The female coupler end includes a bore sidewall 90 having an inner circumference 92 and an outer circumference 94. The bore sidewall includes a recessed portion 96 between the inner circumference and the outer circumference adjacent an outer lip 98 of the bore sidewall, and thereby, enlarging the bore 56 at the recessed portion 96. The non-circular shape of the bore 56 could be any regular or irregular shape, just as long as it is not a circle relative to a cross-section taken orthogonal to longitudinal axis 64. Such non-circular shape could be oval, square, rectagonal, triangular, symmetrical, non-symmetrical, polygonal, circular with only a portion non-circular (e.g., a protrusion on the male or female member and a mating recess for the protrusion on the female or male member, respectively, or a keyed relationship), the combination of any of these or similar variations. The shape of bore 56 is only limited by the shape of circumference 36 of the male coupler end, because bore 56 must be adapted to releasably receive the male coupler end 36 within the female coupler end such that when the female coupler end and the male coupler end are releasably engaged together they can rotate axially relative to one another only between the ranges 60 of greater than −180 degrees and less than 180 degrees. That is, the engaged relationship and the non-circular feature of ends 32, 52, will not allow them to rotate axially past angle 62, which diagrammatically represents +/−180 degrees relative to any starting rotational position of the ends 32, 52. Without being limited to a theory of understanding, it is believed that in this way the present invention provides a significant advantage over the prior art by enabling the ends 32, 52 to handle the rotational torque forces placed upon the drive shaft during operation thereof, rather than principally relying upon other components or mechanisms of the coupler to do this.

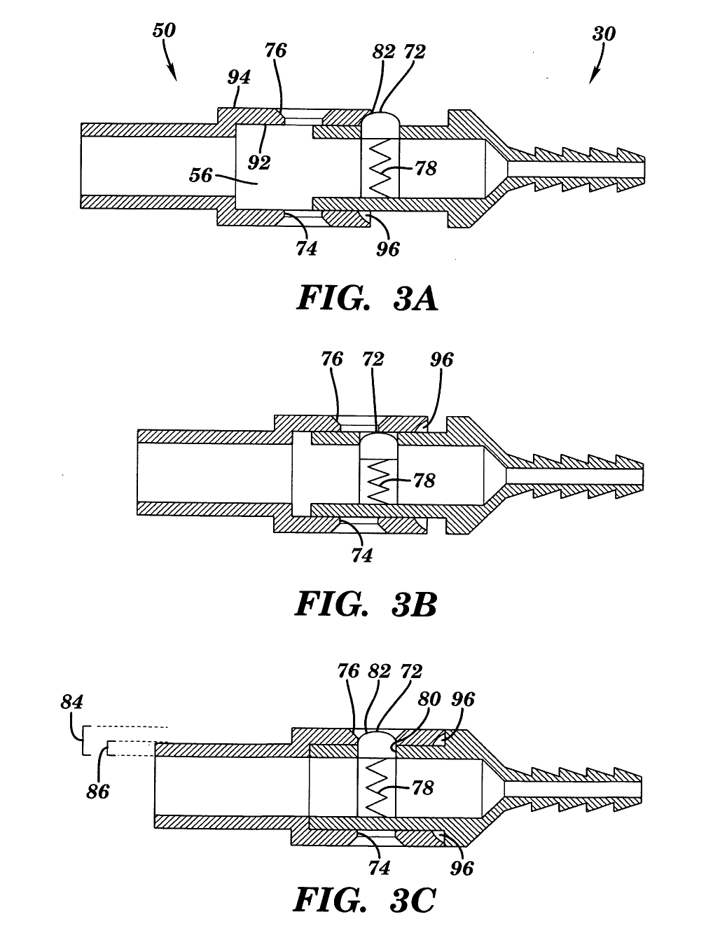

A detent 70 cooperatively engages the male and female members 30, 50 to lock the male and female ends 32, 52 together when the male coupler end is received within the female coupler end. In this way, disengagement of members 30, 50 in the longitudinal direction 64 is prevented. Also, though not required, detent 70 io may assist in preventing axial movement of ends 32, 52 during operation of the drive shaft. The detent can be a depressible button 72 and a cooperative recess 74 that receives the button when the male and female members are engaged together. More particularly, the button 72 may be located on the male member 30 and recess 74 may be located on the female member 50. The button may be actuated by a spring 78, or similar functioning structure, all depending on the operation of the detent. The button is operable between an extended position (FIGS. 1, 2, 3A, 3C and 5) and a depressed position (FIG. 3B), such that the button 72 is received by the recess 74 when the button is in the extended position and the male member and the female members are releasably engaged together. The recess may also include scalloped area 76 around the recess, to aid in disengagement of the detent from the members 30, 50 when it is desired to disconnect members 30, 50.

Referring to FIG. 3C, the button may include a cylindrical base 80 with an angled cap 82 on top of the cylindrical base. Angled cap 82 may be a flat surface sloped from one side of the cylindrical base 80 to the other side (not shown), or multiple flat surfaces sloped from one side of the cylindrical base 80 to the other side (not shown) or a center portion (not shown), or a curved surface or surfaces sloped from one side of the cylindrical base 80 to the other side (not shown) or to a center s portion so as to be dome shaped (as shown in all the Figures except 4), or a combination of such of these surfaces (only the domed curved surface is specifically shown). Without being limited to a theory of operation, and as explained further below and in reference to FIGS. 3A, 3B and 3C, it is the relationship between the button 72, the recessed portion 96, and the cooperative recess 74, that together io enable the quick-connect of the male member 30 into the female member 50 unlike ever before possible. In this regard, for example as seen in FIGS. 1 and 2, inclusive, the detent 70 can be located on a side of the male and female members 30, 50, respectively, and the recessed portion 96 can be located on the same side of the female member in a location corresponding to the detent. A still further advantage, for example as seen in FIGS. 3A to 4, inclusive, can be realized when the detent 70 includes a pair of detents 70, with each detent being located on an opposite side of the male and female members 30, 50, respectively, and the female coupler end includes a pair of recessed portions 96, with each recessed portion located on an opposite side of the female member in a location corresponding to each of the pair of detents 70.

The angled cap engages the recessed portion in a first position, as seen in FIG. 3A, when the male member 30 begins to be received into the bore 56 and the button 72 is in the extended position. The angled cap 82 then engages the bore 56 in a second position, as seen in FIG. 3B, when the male member is further received into the bore 56 and the button is in the depressed position. The angled cap 82 is spaced from the recessed portion 96 and received in the cooperative recess 74 in a third position , as seen in FIG. 3C, when the male member 30 and the female member 50 are releasably engaged together and the button 72 is in the extended position.

The invention may also include a variety of other features. For example, and referring to the remainder of Figures as well, the detent may principally serve to prevent disengagement of the male member from the female member in longitudinal direction 64, such that detent 70 does not substantially prevent axial movement 60 of the male member relative to the female member when the male and female members are engaged together. In this way, less stress is placed upon the detent and this the detent should have a longer useful life, as well as enable easier connection and disconnection of members 30, 50 because the detent, which is a relatively delicate part, with prior coupler devices has a tendency to jam between the coupler ends making more difficult or impossible their disconnection when desired.

Additionally, or alternatively, and following upon the reasons just discussed, the non-circular circumference of the male coupler end may be oval shaped. The bore of the female coupler end may similarly include an oval shape. When both ends 32, 52 are provided with an oval shape, or any other complimentary shapes for that matter, the female coupler end and the male coupler end may be made to engage each other in a mated relationship. More particularly, the mated relationship may enable substantially no axial rotation of the male member relative to the female member.

Other features the invention may include are optional features of button 72. For example, the button in the extended position (FIG. 3C, as one example shown) can have a height distance 84 greater than the inner circumference 92 of the bore sidewall 90 and even with to less than the outer circumference 94 of the bore sidewall. Alternatively, or additionally, when the button is in the extended position (FIG. 3C, as one example shown) the cylindrical base 80 can have a height distance 86 greater than the inner circumference 92 of the bore sidewall and even with to less than the outer circumference 94 of the bore sidewall. In these ways, the to button can be sized and shaped to engage the recessed portion 96 for optimal quick-connect relationships. For example, this can be understood further in the context of the method for the invention, as described herein.

The invention also includes a method for joining locking coupler 10 for the drive shaft 22, 24, with the locking coupler having the features as described previously. Referring to FIG. 3A, the method includes pushing the male member 30 into the bore 56 such that the angled cap 82 engages the recessed portion 96 and the button is in the extended position. Next, and referring to FIG. 3B, the method includes pushing further the male member 30 into the bore such that the angled cap 82 engages the bore 56 and the button is in the depressed position. Still further, and referring to FIG. 3C, the method includes engaging releasably together the male member 30 and the female member 50 such that the angled cap 82 is spaced from the recessed portion 96 and received in the cooperative recess 74 and the button is in the extended position. Finally, the method includes limiting axial rotation of the male member 30 relative to the female member 50 when the female coupler end and the male coupler end are engaged together. The method may also include, advantageously, automatically aligning the male and female members due to the location of the pair of recessed portions 96. Still further, automatically aligning may include aligning the male and female members due to the location of the pair of recessed portions 96 in combination with the non-circular circumference portions of the male and female members. The method may also include, advantageously, each pushing step being engaging manually (not shown) the male shaft end and the female shaft end and thereby pushing the male coupler end into the female coupler end. Still further, and of most advantage for quick-connect joining of the male and female members, if desired, each pushing step may include engaging manually only the male shaft end and the female shaft end without manually engaging the button. As one example, through the combination of the features of the button 72 (or plural buttons, not shown), the recessed portion(s) 96, the non-circular bore 56 which receives the non-circular circumference 36, and the cooperative recess(es) 74, the user of coupler 10 need only manually grasp the male shaft end 34 in one hand and the female shaft end 54 in his/her other hand and then move his/her hands together to readily cause the coupler 10 to move through the positions seen in FIGS. 3A to 3B to 3C, and thereby quick-connect the coupler 10, all with the user not having to ever manually depress button 72.

Still other features the invention may include depend upon the type of drive shaft desired for use with the coupler 10. For example, at least one of the male shaft end or the female shaft end may have a serrated outer circumference adapted to securely attach a portion of a drive shaft thereover, as seen with the male shaft end in FIG. 1. As another example, at least one of the male shaft end or the female shaft end may be adapted to securely attach a portion of a drive shaft therein, as seen with the female shaft end 54 in FIG. 1. As yet another example, at least one of the male shaft end or the female shaft may have a non-circular circumference 40, as seen with the male shaft end. Such circumference 40 may be adapted to fit within a mating drive shaft or other component of a drive shaft system, such as a cleaning brush.

The coupler may be made of various materials. Such materials to advantageously have a rigid characteristic so as to be able to endure the rotational torque stresses the coupler will be subjected to during its intended lifetime. For example, these may be metals, plastics and substitutes therefor as would be known to those of skill in the art, and such things as steel, galvanized steel and molded plastics may be employed. The male and female members may be formed by conventional techniques such as cutting, grinding, molding, forging or other forming means. Members 30, 50 may have hollow cores throughout as shown, or be selectively made to have solid portions, as desired, as long as the end structures are consistent with the teachings of the invention herein. The male and female members and their variety of features may be made to various sizes as long as the relative relationships between certain components, as discussed above, are maintained as desired. Otherwise, generally, the size of the members for which the coupler is intended and the desired attributes of the coupler, will dictate the overall size of the members and their components, as would be known to one of ordinary skill in the art in combination with the teachings herein.

While the invention has been described in connection with various features and advantages, such is not intended to limit the scope of the invention to the particular form set forth, but, on the contrary, the invention is intended to cover such alternatives, modifications and equivalents as may be defined by the scope of the following claims.

What is claimed is:

1. A locking coupler for a drive shaft comprising:
a male member including a male coupler end and an opposite male shaft end, wherein the male coupler end has a non-circular circumference relative to an axis of the male member;
a female member including a female coupler end and an opposite female shaft end, wherein the female coupler end includes a non-circular bore adapted to releasably receive the male coupler end within the female coupler end such that when the female coupler end and the male coupler end are releasably engaged together they can rotate axially relative to one another only between the ranges of greater than −180 degrees and less than 180 degrees;
a detent cooperatively engageable with the male and female members to lock the male and female ends together when the male coupler end is received within the female coupler end, wherein the detent comprises a button operable between an extended position and a depressed position and a cooperative recess that receives the button when the button is in the extended position;
the female coupler end including a bore sidewall having an inner circumference and an outer circumference with the bore sidewall including a recessed portion between the inner circumference and the outer circumference adjacent an outer lip of the bore sidewall and thereby enlarging the bore at the recessed portion; and
the button including a cylindrical base with an angled cap on top of the cylindrical base and the angled cap engaging the recessed portion in a first position when the male member begins to be received into the bore and the button is in the extended position, the angled cap engaging the bore in a second position when the male member is further received into the bore and the button is in the depressed position, and the angled cap is spaced from the recessed portion and received in the cooperative recess in a third position when the male member and the female member are releasably engaged together and the button is in the extended position.

2. The locking coupler of claim 1 wherein the detent principally serves to prevent disengagement of the male member from the female member in a longitudinal direction of the members and the detent does not substantially prevent axial movement of the male member relative to the female member when the male and female members are engaged together.

3. The locking coupler of claim 1 wherein the non-circular circumference of the male coupler end is oval shaped.

4. The locking coupler of claim 1 wherein the non-circular bore of the female coupler end is oval shaped.

5. The locking coupler of claim 3 wherein the non-circular bore of the female coupler end is oval shaped.

6. The locking coupler of claim 1 wherein the female coupler end and the male coupler end engage each other in a mated relationship.

7. The locking coupler of claim 6 wherein the mated relationship enables substantially no axial rotation of the male member relative to the female member.

8. The locking coupler of claim 1 wherein the button in the extended position has a height distance greater than the inner circumference of the bore sidewall and even with to less than the outer circumference of the bore sidewall.

9. The locking coupler of claim 1 wherein when the button is in the extended position the cylindrical base has a height distance greater than the inner circumference of the bore sidewall and even with to less than the outer circumference of the bore sidewall.

10. The locking coupler of claim 1 wherein the depressible button is located on the male member and the cooperative recess is located on the female member.

11. The locking coupler of claim 1 wherein at least one of the male shaft end or the female shaft end has a serrated outer circumference adapted to securely attach a portion of a drive shaft thereover.

12. The locking coupler of claim 1 wherein at least one of the male shaft end or the female shaft end is adapted to securely attach a portion of a drive shaft therein.

13. The locking coupler of claim 1 wherein the detent comprises a pair of detents, each detent located on an opposite side of the male and female members, and the female coupler end includes a pair of recessed portions, each recessed portion located on an opposite side of the female member in a location corresponding to each of the pair of detents.

14. The locking coupler of claim 1 wherein the detent is located on a side of the male and female members and the recessed portion is located on the same side of the male and female members in a location corresponding to the detent.

15. A locking coupler for a drive shaft comprising:
a male member including a male coupler end and an opposite male shaft end, wherein the male coupler end has a non-circular circumference portion relative to an axis of the male member;
a female member including a female coupler end and an opposite female shaft end, wherein the female coupler end includes a non-circular bore portion adapted to releasably receive the male coupler end within the female coupler end such that the female coupler end and the male coupler end engage each other in a mated relationship which provides substantially no axial rotation of the male member relative to the female member;
a detent cooperatively engageable with the male and female members to lock the male and female ends together when the male coupler end is received within the female coupler end, wherein the detent comprises a button operable between an extended position and a depressed position and a cooperative recess that receives the button when the button is in the extended position and wherein the detent principally serves to prevent disengagement of the male member from the female member in a longitudinal direction of the members and the detent does not substantially prevent axial movement of the male member relative to the female member when the male and female members are engaged together;
the female coupler end including a bore sidewall having an inner circumference and an outer circumference with the bore sidewall including a recessed portion between the inner circumference and the outer circumference adjacent an outer lip of the bore sidewall and thereby enlarging the bore at the recessed portion; and
the button including a cylindrical base with an angled cap on top of the cylindrical base and the angled cap engaging the recessed portion in a first position when the male member begins to be received into the bore and the button is in the extended position, the angled cap engaging the bore in a second position when the male member is further received into the bore and the detent is in the depressed position, and the angled cap is spaced from the recessed portion and received in the cooperative recess in a third position when the male member and the female member are releasably engaged together and the button is in the extended position.

16. A method for joining a locking coupler for a drive shaft, the locking coupler comprising:
a male member including a male coupler end and an opposite male shaft end, wherein the male coupler end has a non-circular circumference portion relative to an axis of the male member;
a female member including a female coupler end and an opposite female shaft end, wherein the female coupler end includes a non-circular bore portion adapted to releasably receive the male coupler end within the female coupler end, the female coupler end including a bore sidewall having an inner circumference and an outer circumference with the bore sidewall including a recessed portion between the inner circumference and the outer circumference adjacent an outer lip of the bore sidewall and thereby enlarging the bore at the recessed portion;
a detent cooperatively engageable with the male and female members to lock the male and female ends together when the male coupler end is received within the female coupler end, the detent comprising a button and a cooperative recess that receives the button and the button is operable between an extended position and a depressed position and includes a cylindrical base with an angled cap on top of the cylindrical base;
the method comprising:
pushing the male member into the bore such that the angled cap engages the recessed portion and the button is in the extended position;
pushing further the male member into the bore such that the angled cap engages the bore and the button is in the depressed position;
engaging releasably together the male member and the female member such that the angled cap is spaced from the recessed portion and received in the cooperative recess and the button is in the extended position; and,
limiting axial rotation of the male member relative to the female member when the female coupler end and the male coupler end are engaged together.

17. The method of claim 16 wherein the detent comprises: a pair of detents, each detent located on an opposite side of the male and female members, and the female coupler end includes a pair of recessed portions, each recessed portion located on an opposite side of the female member in a location corresponding to each of the pair of detents; and, the method further comprises automatically aligning the male and female members due to the location of the pair of recessed portions.

18. The method of claim 17 wherein automatically aligning further comprises aligning the male and female members due to the location of the pair of recessed portions in combination with the non-circular circumference portions of the male and female members.

19. The method of claim 16 wherein each pushing step comprises engaging manually the male shaft end and the female shaft end and thereby pushing the male coupler end into the female coupler end.

20. The method of claim 19 wherein each pushing step comprises engaging manually only the male shaft end and the female shaft end without manually engaging the button.
